(19) United States
(12) Patent Application Publication
(10) Pub. No.: US 2025/0202719 A1
(43) Pub. Date: Jun. 19, 2025

(54) CHALLENGE MANAGER

(71) Applicants: Ajit Gaddam, Danville, CA (US); Nicholas Richard Gillis, Martinsburg, WV (US); Michael J. Quinlan, San Francisco, CA (US)

(72) Inventors: Ajit Gaddam, Danville, CA (US); Nicholas Richard Gillis, Martinsburg, WV (US); Michael J. Quinlan, San Francisco, CA (US)

(21) Appl. No.: 18/541,702

(22) Filed: Dec. 15, 2023

(51) Int. Cl. H04L 9/32; G06N 3/048; H04L 9/40

(52) U.S. Cl. CPC H04L 9/3271; G06N 3/048; H04L 63/10

(57) ABSTRACT

Systems, methods, and techniques herein for challenge-response protocols can include receiving, from a user device, a request for a resource. A target work capacity of the user device is determined using a machine-learning (ML) model. A proof-of-work problem is selected from a plurality of proof-of-work problems, each proof-of-work problem in the plurality of proof-of-work problems having scalable work capacity. A work capacity of the selected proof-of-work problem is scaled to utilize at least the target work capacity. The scaled proof-of-work problem is provided to the user device. A proof-of-work is received from the user device in response to the scaled proof-of-work problem. Whether the received proof-of-work is a valid solution to the scaled proof-of-work problem is determined.

### BACKGROUND

Enterprises provide access to gated content, resources, and services through channels. Enterprises receive requests to access content, resource, or service from both legitimate users and attackers. A legitimate user can gain access to gated content, resource, or service in response to an enterprise authorizing the user, for example, a user login. Attackers, such as fraudulent users, hackers, and bots, may attempt to illegitimately access gated content, resource, or service by launching an attack. For example, a bot may launch an attack that includes multiple illegitimate login attempts in rapid succession. Further, attackers have access to free platform services to facilitate aspects of their attacks. When one source of an attack is blocked by an enterprise, an attacker can instantiate a new free instance and continue launching attacks.

Enterprises try to balance deterring attackers and enabling legitimate users to access content, resource, or service=without excessive inconvenience. Legitimate users may respond to excessive inconvenience from security protocols by taking their business to another enterprise. Enterprises have a need for improved deterrents on attackers that minimally impacts legitimate users.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a diagrammatic representation of a networked environment in which the present disclosure may be deployed, according to some examples.

FIG. 2 is a diagrammatic representation of a challenge system that has both device-side and server-side functionality, according to some examples.

FIG. 3 is a diagrammatic representation of a challenge management system, according to some examples.

FIG. 4 illustrates a machine-learning pipeline, according to some examples.

FIG. 5 illustrates training and use of a predictive model, according to some examples.

FIG. 6 is a diagrammatic representation of a user system interacting with the challenge management system, according to some examples.

FIG. 7 illustrates a flowchart showing a technique for deterring attacks, according to some examples.

FIG. 8 illustrates generally an example of a block diagram of a machine upon which any one or more of the techniques discussed herein may perform in accordance with some examples.

### DETAILED DESCRIPTION

The systems, methods, and techniques described herein may be used to deter fraudulent attacks on an enterprise by issuing a challenge to a user device in response to a potentially fraudulent request for content, resource, or service. The system forces the user device to provide a proof of solving the challenge (e.g., a proof-of-work) in order to access the requested content, resource, or service. The challenges can be scaled dynamically to be unpredictable to attackers and resistant to parallel processing. The systems, methods, and techniques related to the challenges can deter attackers while not or only nominally inconveniencing legitimate customers.

Attackers continue to innovate new forms of attacks on enterprises while enterprises are reacting to these new fraudulent attacks. In contrast to conventional approaches to enterprise security, the systems, methods, and techniques described herein can provide a more proactive response to attacks through dynamically changing the challenges. The challenges are scalable, and can be changed responsive to each access attempt. As a result, an attacker cannot predict or circumvent the challenge.

The challenges can include one or more logic problems, such as proof-of-work problems. A potential attacker is forced to perform tasks in solving a respective proof-of-work to generate a proof-of-work. The user device provides the proof-of-work and, in response to validating the proof-of-work, access may be granted to the user device. The proof-of-work problems can include cryptographic problems, satisfiability problems, network transmission problems, and a chained combination thereof. The proof-of-work problems can be dynamically changed for a particular user device to a target complexity. The target complexity can be achieved by a scaling a work capacity of the proof-of-work problem to a determined target work capacity of the user device. The work capacity of a proof-of-work problem is a computational capacity that will be consumed on a user device for the user device to generate the proof-of-work. The target work capacity can comprise processing capacity, memory capacity, and network traffic capacity. In issuing a challenge, the system dynamically scales the work capacity of one or more proof-of-work problems issued as a challenge to, for example, be unpredictable to attackers.

One or more machine learning (ML) model(s) can be used to help generate a challenge. For example, one or more ML models may determine the target work capacity of the user device making the request for access. The one or more ML model(s) may make use of artificial intelligence (AI) to intelligently predict whether a user device is associated with an attacker or a legitimate user. The one or more ML model(s) can be trained using historical access data. Additionally, or alternatively, the one or more ML model(s) can collect data on suspected or known attackers after deployment to improve abilities to identify attackers. Further, the one or more ML model(s) may learn from ongoing requests for access to determine combinations in challenges that work best at deterring attacks. The data gathered and ingested by the one or more ML model(s) does not include personally-identifiable information (PII) about users.

The systems, methods, and techniques described herein may be used to change the financial return on investment for the fraudulent user. For example, the work capacity required to solve a challenge can rapidly scale to exceed the capacity available from free platform resources. The more time and capacity fraudulent users invest in attempting to access content, resource, or service of the enterprise, the less time and capacity the fraudulent user has available to make profit.

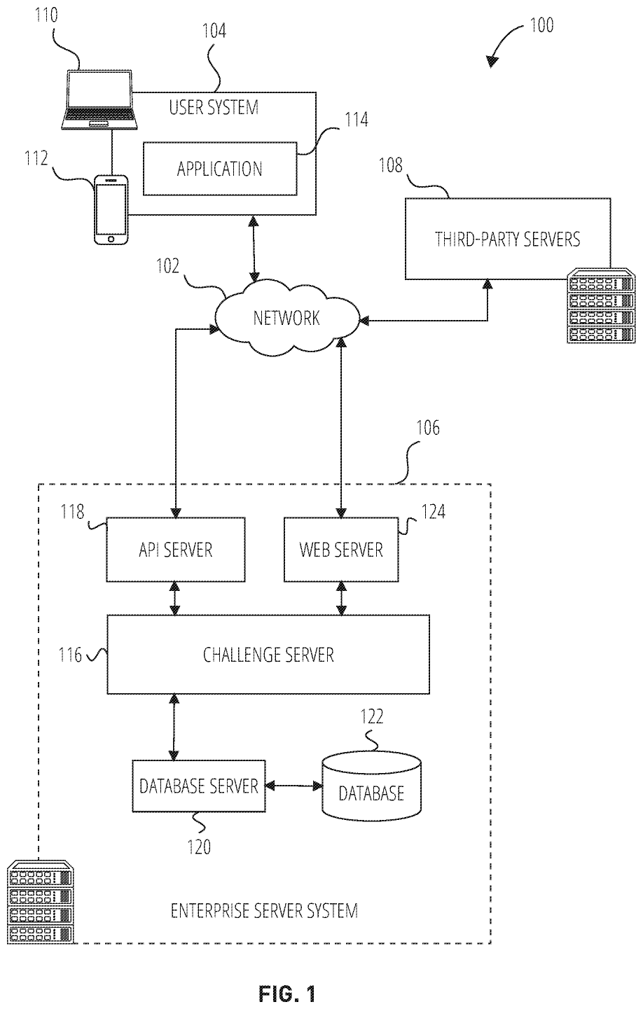

FIG. 1 is a diagrammatic representation of a networked environment in which the present disclosure may be deployed, according to some examples. FIG. 1 includes a block diagram showing an example enterprise system 100 for communicating over a network 102 (e.g., the Internet). The enterprise system 100 includes one or more user systems 104. According to some examples, each user system 104 is communicatively coupled, via one or more communication networks including the network 102, to an enterprise server system 106 and, optionally, third-party servers 108.

The user system 104 may be associated with a legitimate user or an attacker. The user system 104 can include one or more user devices, such as a computer device 110 or a mobile device 112, that are communicatively connected to exchange data (e.g., via the network 102). According to some examples, the computer device 110 is an automated teller machine (ATM). The user system 104 may be configured for voice calls (e.g., cell phone, voice over internet protocols, etc.).

The user system 104 can host at least one application 114. The application 114 can be a local instance of a client application of an enterprise or a web browser. The application 114 can communicate with other locally hosted applications 114 using APIs and can communicate with the network 102 via the user system 104.

The user system 104 interacts with the enterprise server system 106 via the network 102. The data exchanged between the user systems 104 and between the user systems 104 and the enterprise server system 106 can include functions (e.g., commands to invoke functions) and payload data (e.g., files, text, audio, video, or other data).

The enterprise server system 106 provides server-side functionality via the network 102 to the user systems 104. While certain functions of the enterprise system 100 are described herein as being performed by either by the enterprise server system 106 or subsystems thereof, the location of certain functionality either within the enterprise server system 106 or the application 114 of the user system 104 may be a design choice. For example, it may be technically preferable to initially deploy particular technology and functionality within the enterprise server system 106 but to later migrate this technology and functionality to the application 114 where a user system 104 has sufficient processing capacity. Additionally, or alternatively, the enterprise server system 106 is able to provide, store, and modify device-side data (e.g., browser cookies, web storage such as local or session storage).

The enterprise server system 106 supports various services and operations that are provided to the user system 104. Such operations include receiving requests from, transmitting data to, receiving data from, and processing data from the user system 104. This data may include payload data, device information, geolocation information, passwords and user information, among other information. Data exchanges within the enterprise system 100 are invoked and controlled through functions available via user interfaces (UIs) of the user system 104.

Turning now specifically to the enterprise server system 106, an Application Program Interface (API) server 118 is connected to and provides programmatic interfaces to challenge server 116 making the functions of the challenge server 116 accessible to an application 114 of a user system 104, and third-party servers 108. The challenge server 116 is communicatively coupled to a database server 120, facilitating access to a database 122 that stores data associated with challenges associated with the challenge server 116. Similarly, a web server 124 is coupled to the challenge server 116 and provides web-based interfaces to the challenge server 116. To this end, the web server 124 processes incoming network requests over the Hypertext Transfer Protocol (HTTP) and several other related protocols.

The API server 118 receives and transmits data (e.g., challenge problems, proof-of-work) between the challenge server 116 and the user system 104 (e.g., the application 114) and the third-party servers 108. Specifically, the API server 118 provides a set of interfaces (e.g., routines and protocols) that can be called or queried by the user system 104 (including e.g., the application 114) to invoke functionality of the challenge server 116. The API server 118 exposes various functions supported by the challenge server 116, including account registration; login functionality; transmitting data to the user system 104 (e.g., challenge problems); transmitting data from the user system 104 to the challenge server 116 (e.g., a solution to a challenge problem, associated proof-of-work); the retrieval of challenge problems or other data; among other data exchanges described herein.

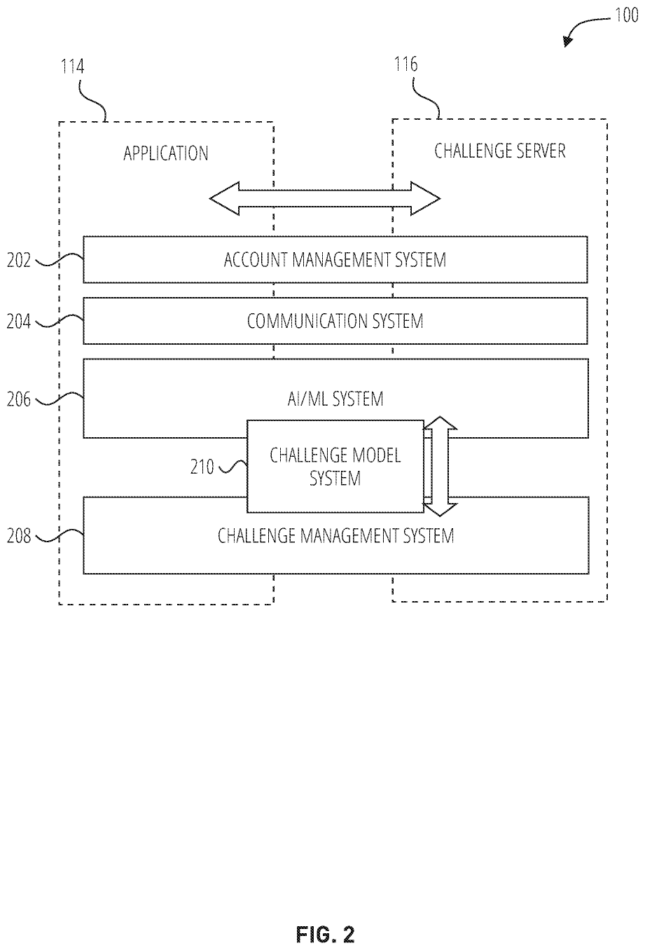

The challenge server 116 can host multiple systems and subsystems, described below with reference to FIG. 2.

FIG. 2 is a block diagram illustrating further details regarding the enterprise system 100, according to some examples. Specifically, the enterprise system 100 is shown to comprise the application 114 and the challenge server 116. The enterprise system 100 can embody multiple subsystems, which are supported on the device-side by the application 114 and on the server-side by the challenge server 116. In some examples, these subsystems are implemented as microservices. A microservice subsystem (e.g., a microservice application) may have components that enable it to operate independently and communicate with other services. Example components of microservice subsystem may include:
Function logic: The function logic implements the functionality of the microservice subsystem, representing a specific capability or function that the microservice provides.
API interface: Microservices may communicate with each other components through well-defined APIs or interfaces, using lightweight protocols such as REST or messaging. The API interface defines the inputs and outputs of the microservice subsystem and how it interacts with other microservice subsystems of the enterprise system 100.
Data storage: A microservice subsystem may be responsible for its own data storage, which may be in the form of a database, cache, or other storage mechanism (e.g., using the database server 120 and database 122). This enables a microservice subsystem to operate independently of other microservices of the enterprise system 100.
Service discovery: Microservice subsystems may find and communicate with other microservice subsystems of the enterprise system 100. Service discovery mechanisms enable microservice subsystems to locate and communicate with other microservice subsystems in a scalable and efficient way.
Monitoring and logging: Microservice subsystems may need to be monitored and logged in order to ensure availability and performance. Monitoring and logging mechanisms enable the tracking of health and performance of a microservice subsystem.
Reading and writing: Certain microservice subsystems may be enabled to read and write files. Microservices may leverage templating libraries to write to files served to a user device. Reading and writing mechanisms enable faster execution of issuance of challenges by reducing server and database queries.

In some examples, the enterprise system 100 may employ a monolithic architecture, a service-oriented architecture (SOA), a software-as-a-service (SaaS) architecture, a function-as-a-service (FaaS) architecture, or a modular architecture:

An account management system 202 is operationally responsible for the management of user accounts and associated data, and maintains entity information (e.g., stored in entity tables) regarding user accounts of users of the enterprise system 100. The account management system 202 can manage account authentication services between the application 114 and the challenge server 116. For example, in response to a valid authentication request, the challenge server 116 provides a proof of authorization (e.g., browser cookie, JSON web token (JWT)) for use throughout a session. In some examples, a challenge is not issued if an application 114 maintains a valid proof of authorization throughout a session.

The account management system 202 may enable additional services associated with a user account, such as banking services (e.g., deposits, withdrawals, and other transactions), including automated banking services (e.g., automated teller machine transactions), and account management services (e.g., open an account, close an account, view statements). The account management system 202 may collect and maintain access data associated with requests for accessing content, resource, or services.

The communication system 204 enables and supports communication between a user system 104 and the enterprise server system 106. For example, the communication system 204 can enable and support messaging and audio communications (e.g., real-time messaging or audio calling) between a user system 104 and the enterprise system 100. For example, a user can access customer support through the communication system 204.

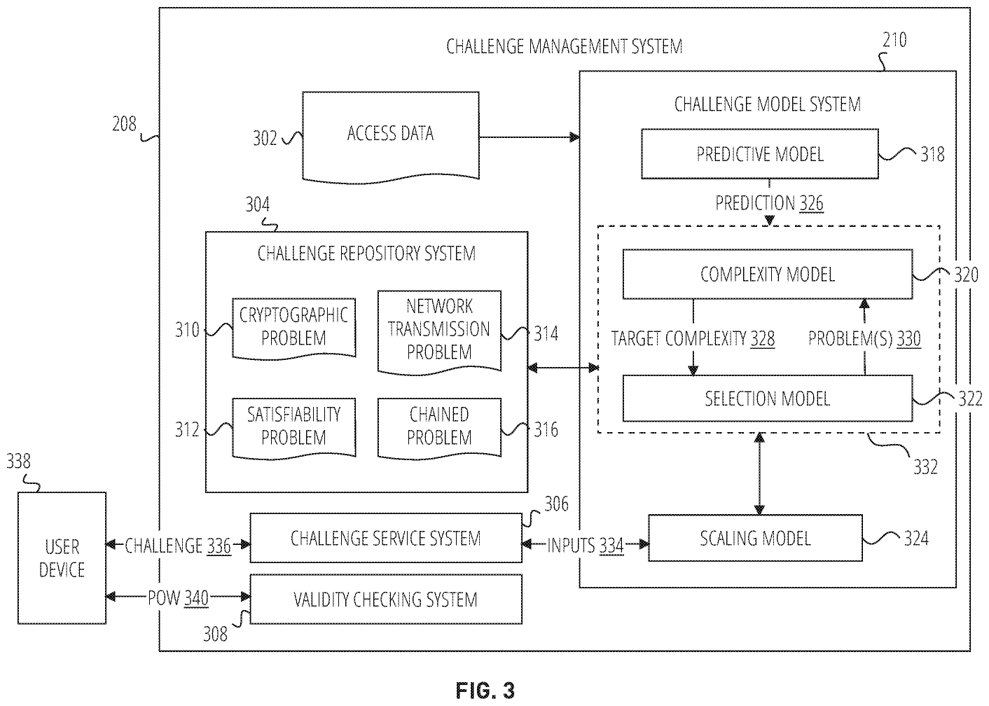

An artificial intelligence and machine learning system 206 provides a variety of services to different subsystems within the enterprise system 100. For example, the artificial intelligence and machine learning system 206 may train one or more ML models in a challenge model system 210 for use by a challenge management system 208. According to some examples, the artificial intelligence and machine learning system 206 operates with the account management system 202 to analyze access data and extract features for the challenge model system 210. The challenge model system 210 is described below with reference to FIG. 3.

The artificial intelligence and machine learning system 206 may also work with the communication system 204 to provide speech recognition and natural language processing capabilities, allowing users to interact with the enterprise system 100 using voice commands.

The challenge management system 208 is operationally responsible for managing the fraud challenges. The challenge management system 208 hosts multiple systems and subsystems, described below with reference to FIG. 3.

FIG. 3 is a diagrammatic representation of the challenge management system 208, according to some examples. The challenge management system 208 can include or otherwise have access to (e.g., via the network 102) access data 302 and the challenge model system 210. The challenge management system 208 is shown to comprise several additional subsystems including a challenge repository system 304, a challenge service system 306, and a validity checking system 308. According to some examples, the challenge management system 208 can include additional or fewer subsystems, and functionality can be distributed differently among the subsystems. The challenge management system can provide a challenge 336 to a user device 338 requesting access to content, resource or service, where the user device 338 can comprise an example of the user system 104.

### Access Data

The access data 302 can store data relating to requests for access from user systems 104. The access data 302 may be stored within the database 122 and accessed by the challenge management system 208 via the network 102. The access data 302 may be collected by the account management system 202, according to some examples.

The access data 302 can include historical access data associated with a particular user account. In some examples, the historical access data can include one or more counters associated with the user account. For example, the historical access data 302 may include a counter of failed access attempts, a counter of successful access attempts, and additionally, or alternatively, counters associated with any data discussed in the below paragraphs.

The access data 302 can include data associated with the user device 338, such as device fingerprint, device type, bit rate, a device processing capacity, a device memory capacity, a device network traffic capacity, operating system, and other non-PII data that can be determined from exchanges between the enterprise and the user device 338.

Additionally, or alternatively, the access data 302 can include data tracked by the application 114, such as data relating to input device events (e.g., click events, drag and drop events, keyboard events, touchscreen events, button events, joystick events), data relating to Document Object Model (DOM) events (e.g., load events, error events, focus events (e.g., foregrounding), progress events, HTML form events, and DOM manipulation events), timestamps thereof, and any other non-PII data that can be determined from inputs provided by the user of the user device 338 to the application 114.

Additionally, or alternatively, the access data 302 can include payload and metadata about the request to access content, resource, or service, such as date, time, language, IP address of the user device 338. In some examples involving HTTP requests, the access data 302 can include other data that may be located in the header of an HTTP request or an associated payload.

In examples where the request to access content, resource, or service occurs over customer support communications, the communications can provide access data 302. In some examples where the request occurs in an audio call, the challenge management system 208 may collect access data 302 of various non-PII data relating to audio inputs to determine whether a caller is an AI-generated voice bot (e.g., audible clicks, long pauses, etc.). In some examples where the request occurs in a messaging chat, the challenge management systems 208 can collect access data 302 relating to messaging inputs to determine whether the user is an AI-generated messaging bot (e.g., rapid responses, etc.).

In examples where the request to access content, resource, or service occurs at an ATM, the challenge management system 208 may collect non-PII access data 302, such as data associated with entering a personal identification number (PIN) (e.g., speed and strokes of entering the PIN), which may be used to identify fraudulent access requests.

### Challenge Repository System

The challenge repository system 304 maintains a plurality of proof-of-work problems that can be issued as challenges. A proof-of-work problem is a computational problem whose solution includes a proof-of-work. Each proof-of-work problem maintained by the challenge repository system 304 has a scalable complexity. In some examples, the scalable complexity is a scalable work capacity necessary to generate the proof-of-work.

The challenge repository system 304 is shown to comprise different types of proof-of-work problems: one or more cryptographic problems 310, one or more satisfiability problems 312, one or more network transmission problems 314, and one or more chained problems 316. The challenge repository system 304 may include additional or alternate types of proof-of-work problems than those shown in FIG. 3.

According to some examples, the proof-of-work problems maintained by the challenge repository system 304 are associated with asymmetric computations, where the computations to generate the proof-of-work are more complex than the computations by the challenge management system 208 to check the validity of the generated proof-of-work. In some examples, the challenge repository system 304 can maintain problems that have non-deterministic polynomial-time (NP) computational complexity, such as NP-complete, or NP-hard.

A user device 338 generates a proof-of-work 340 in solving a respective proof-of-work problem. According to some examples, each proof-of-work problem in the plurality of proof-of-work problems maintained by the challenge repository system 304 has a scalable work capacity. The work capacity is a capacity (e.g., processing capacity, memory capacity, network capacity) to be consumed on the user device 338 in solving the proof-of-work problem in order to generate the proof-of-work 340.

The work capacity associated with a particular proof-of-work problem stored by the challenge repository system 304 can be scaled dynamically by the challenge service system 306 at the issuance of each challenge. By dynamically scaling the work capacity required to solve a proof-of-work problem in a challenge, an attacker cannot make predictions about the challenge or build up a codebase to circumvent the challenge. The user device 338 is obligated to solve the challenge through brute force.

A cryptographic problem 310 is a proof-of-work problem that uses a cryptographic algorithm, such as a hashing function. According to some examples, a cryptographic problem 310 comprises a one-way cryptographic algorithm (e.g., hashing function) and one or more constraints. The user device 338, through brute force, determines an input to the one-way cryptographic algorithm whose output meets the one or more constraints. The user device 338 provides the input whose output meets the one or more constraints as the proof-of-work 340.

The cryptographic algorithm can comprise a plurality of logical operators and a plurality of hashing constants. Conventional secure hash algorithms (e.g., SHA-0, SHA-1, SHA-2, SHA-3, etc.) for generalized encryption purposes make use of hashing constants that are prime integers. The hashing constants used in the cryptographic problem 310 may be any integers, rather than only prime integers, because the hashing constants are being used for verification rather than generalized encryption. For example, −2 may be used as a hashing constant in a cryptographic problem 310. Moreover, a one-way cryptographic algorithm (e.g., a hashing function) used in a cryptographic problem 310 can be unique and not published. The cryptographic problems 310 are resistant to multithreading and the user device 338 may be forced to brute force the cryptographic problem 310 in a single processing thread.

According to some examples, a cryptographic problem 310 may take up a large amount of processing capacity and, in some examples, memory capacity, while using little to no network capacity.

A satisfiability problem 312 is a proof-of-work problem involving determining whether and how the satisfiability problem 312 can be satisfied (e.g., evaluated to TRUE). According to some examples, a satisfiability problem 312 comprises an expression (e.g., a propositional formula). The expression comprises a plurality of variables, logical operators (e.g., AND, OR, NOT, XOR), and parentheses. In some examples, the expression is divided into clauses, where each clause is separated by a logical operator AND (\hat{ }), and where each clause can comprise parentheses and logical operators OR (V) and NOT (¬), such as:

$$( {x}_{1} ∨ ¬ {x}_{2} ) ∧ ( ¬ {x}_{1} ∨ {x}_{2} ∨ {x}_{3} ) ∧ ¬ {x}_{1}$$

To solve the satisfiability problem 312, the user device 338, through brute force, determines a Boolean value for each variable (e.g., x₁, x₂, x₃) such that the expression evaluates to TRUE, if a solution exists. According to some examples, the user device 338 provides the variable values that evaluate to true as the proof-of-work 340. Satisfiability problems 312 is resistant to multithreading, for example, because the solver performs a depth-first search on the clauses and generates a tree-like structure to solve the satisfiability problem 312.

According to some examples, a satisfiability problem 312 may take up a large amount of processing capacity and memory capacity on the user device 338, while using little to no network capacity. Some satisfiability problems 312 are NP-complete and cannot be solved in polynomial-time.

A network transmission problem 314 is a proof-of-work problem that involves computations that are dependent on communications over a network (e.g., the network 102). According to some examples, a network transmission problem 314 comprises a payload of an initial size and an associated number of transmissions to remote computing devices (e.g., servers, other devices). Each transmission in the associated number of transmissions may be to a different destination (e.g., different server). The user device 338 issues the requests as required to generate the proof-of-work 340, performing computations on or with the initial payload as required. The transmissions and associated computations transform the initial payload; the transformed payload is provided by the user device 338 as the proof-of-work 340.

In some examples, the network transmission problem 314 may involve the user device 338 issuing requests to a plurality of locations for remote payloads (i.e., the associated number of transmissions). The user device 338 performs required computations with the initial payload and the remote payloads to generate the proof-of-work 340. According to some examples, the transmissions and computations must be done in a series, optionally a predefined series. In some such examples, the user device 338 is required to wait for one remote payload before issuing the next request. According to some examples, the user device 338 must retrieve all remote payloads before performing the computations.

In some examples, the network transmission problem 314 requires the user device 338 to provide the initial payload in a first request in the associated number of transmissions. The remote computing device transforms the initial payload and returns a secondary payload to the user device 338. The user device 338 may perform one or more computations on the secondary payload. The user device 338 provides the current payload on the next request in the associated number of transmissions, and so on, for the required number of transmissions. The fully transformed payload is provided by the user device 338 to the challenge management system 208 as the proof-of-work 340.

A network transmission problem 314 can require network activity to generate the proof-of-work 340, thereby making the problem resistant to parallelization as well as optimization through custom hardware. In a network transmission problem 314 the user device 338 is not solely responsible for generating the proof-of-work 340.

According to some examples, a network transmission problem 314 may take up a large amount of network capacity and a variable amount of processing capacity and memory capacity.

A chained problem 316 can comprise any number of the forgoing types of problems issued as a set of problems. That is, a challenge comprising a chained problem 316 can further comprise a set of problems selected from a group consisting of cryptographic problems 310, satisfiability problems 312, and/or network transmission problems 314. According to some examples, the set of problems in the chained problem 316 are a sequence of problems. In some examples, a solution to a problem is an input for a subsequent problem in the sequence of problems The user device 338 is required to solve and present a proof-of-work 340 for each problem in the chained problem 316.

According to some examples, the challenge management system 208 may issue a chained problem 316 that comprises a number of previously issued challenge problems and a number of new challenge problems. For example, a chained problem 316 can comprise the previous nine issued challenges, for which the valid proofs-of-work have already been computed by the challenge management system 208, and a tenth challenge problem, which has not previously been issued. The user device 338 must solve all ten problems and return ten proofs-of-work. The challenge management system 208 need only compute the valid solution to the tenth challenge problem, creating more asymmetry in proof-of-work computations.

### Model System

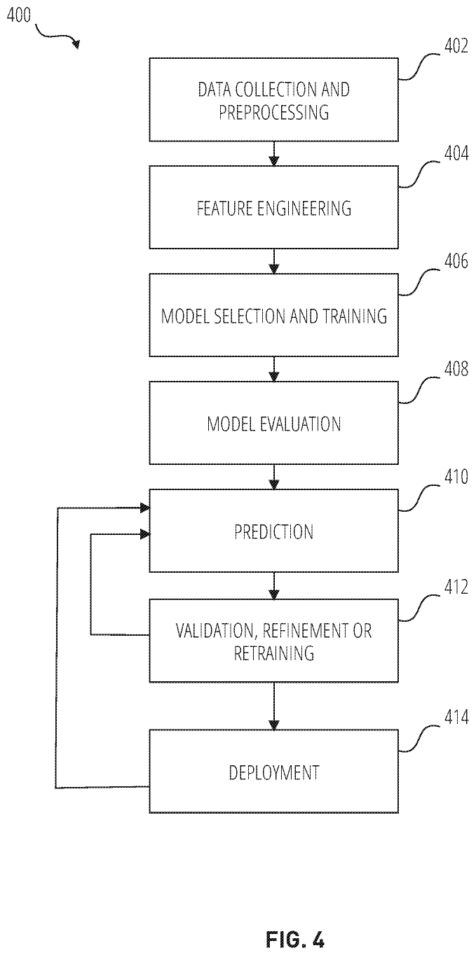

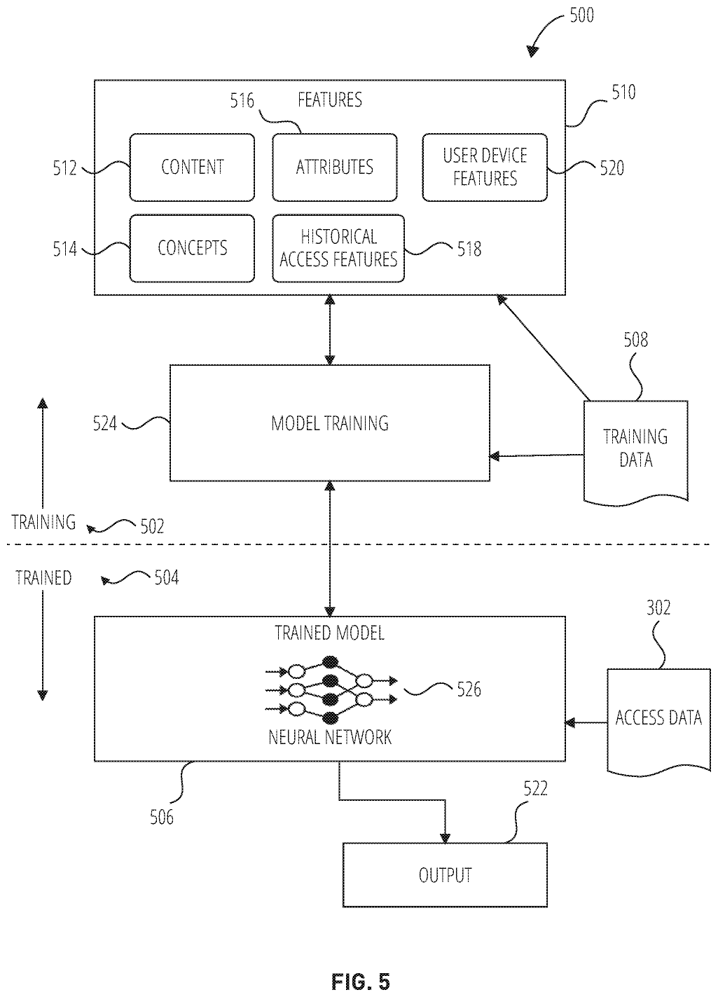

When a user device 338 requests access to content, resource, or service, the challenge model system 210 includes one or more ML models that provide functionality in generating a challenge. According to some examples, the challenge model system 210 may be stored on the challenge server 116 and accessed by the application 114 via the network 102. The training of the one or more ML models in the challenge model system 210 is described below in greater detail in relation to FIG. 4 and FIG. 5.

The challenge model system 210 receives or otherwise has access to the access data 302. Relevant access data 302 may be ingested by the one or more ML models to provide functionality as described below in relation to each model.

The one or more ML models in the challenge model system 210 may operate collectively in a feedback loop to perform operations associated with generating a challenge. It shall be appreciated that the number of ML models and division of functionality described herein among the number of ML models may be a design choice that varies in differing implementations.

The challenge model system 210 is shown to include a predictive model 318, a complexity model 320, a selection model 322, and a scaling model 324. The predictive model 318 can make a prediction 326 to whether the user device 338 making the request for access is likely an attacker. The complexity model 320 can determine a target complexity 328 for a challenge to be issued to the user device 338 requesting access. The selection model 322 can select at least one problem 330 to be issued to the user device 338 requesting access. According to some examples, the complexity model 320 and the selection model 322 are one ML model 332 that selects at least one problem 330 and determines a target complexity 328 for the at least one problem 330. The scaling model 324 dynamically scales the at least one selected problem 330 to the target complexity 328 to generate a challenge.

The predictive model 318 can make a prediction 326 about whether a user device 338 requesting access is an attacker based on relevant access data 302. According to some examples, the predictive model 318 makes a prediction 326 based on determining whether patterns or characteristics associated with attackers are present in the relevant access data 302 associated with the request to access content, resource, or service.

The relevant access data 302 ingested by the predictive model 318 can include data extracted from the present request and, additionally, or alternatively, historical access data 302. The historical access data 302 may be associated with previous requests from the user device 338 or the user account associated with the request. Additionally, or alternatively, the historical access data 302 may include data associated with devices similar to the user device 338. The predictive model 318 may make determinations about which access data 302 is relevant to the present request for access.

Several non-limiting illustrative examples of the predictive model 318 are discussed in the following paragraphs.

According to some examples, where the request is an HTTP request (e.g., GET, PUT, POST), the predictive model 318 ingests relevant access data 302 from the header or payload of the HTTP request. For example, the predictive model 318 may determine the relevant access data 302 fits a pattern associated with attackers based at least in part on an IP address and language extracted from the HTTP request header.

Additionally, or alternatively, the predictive model 318 ingests relevant access data 302 tracking user input. For example, the predictive model 318 may determine relevant access data 302 fits patterns and characteristics associated with attackers based at least in part on patterns of input keystrokes tracked by the application 114.

Additionally, or alternatively, the predictive model 318 ingests relevant access data 302 associated with historical access attempts by the user device 338 making the request. For example, the predictive model 318 may determine the present request is similar to patterns and characteristics of legitimate access attempts by the same user device 338. In another example, the predictive model 318 may predict the user device 338 is likely an attacker based at least in part on historical access data 302 including previous fraudulent access attempts by the user device 338.

Additionally, or alternatively, the predictive model 318 ingests relevant access data 302 associated with historical access attempts by user devices similar to the user device 338 making the request. An individual attacker may be part of a larger group or ‘farm’ of attackers who use similar devices and similar techniques; the predictive model 318 may recognize patterns and characteristics of these devices and techniques. For example, the predictive model 318 may determine there is little or no historical access data 302 associated with the user device 338 making the present request and more heavily weigh access data 302 associated with devices similar to the user device 338 (e.g., similar make or model, similar processing capacity, etc.) in making the prediction 326. The predictive model 318 may predict the user device 338 is likely an attacker based at least in part on similarities to access data 302 of known user devices of attackers.

The foregoing illustrative examples are separated for clarity, and it shall be appreciated that the predictive model 318 may make predictions 326 based on any combination of types of access data 302 relevant to the present request. The predictions 326 made by the predictive model 318 can be used by the complexity model 320 and selection model 322, as discussed further below.

The complexity model 320 can determine a target complexity 328 for a challenge to be issued to the user device 338 requesting access. According to some examples, the complexity model 320 determines the target complexity 328 based at least in part on the prediction 326 about the user device 338 from the predictive model 318. For example, the complexity model 320 may determine a relatively high target complexity 328 responsive to a prediction 326 that the user device 338 is an attacker. In some examples, the complexity model 320 may determine a relatively low target complexity 328 responsive to a prediction 326 that the user device 338 is likely not an attacker (e.g., a legitimate user).

According to some examples, the target complexity 328 is a target work capacity. The challenge is scaled to use at least the target work capacity of the user device 338 in generating the proof-of-work 340. The target work capacity can comprise a processing capacity, a memory capacity, and a network traffic capacity. According to some examples, the target work capacity may further comprise a device temperature.

Processing capacity can comprise capacity of one or more processors of the user device 338, such as capacity of a central processing unit (CPU), and capacity of a graphics processing unit (GPU). Memory capacity can comprise capacity of one or more memories of the user device 338, such as main memory, external memory (e.g., hard disc drives (HDD), solid state drives (SSD), virtual memory, nearline memory (e.g., cloud storage), among other memories that may be used by a user device 338. These memories may be volatile memory (e.g., random access memory (RAM)) or non-volatile memory (e.g., read-only memory (ROM), non-volatile RAM (NVRAM). Network traffic capacity can comprise capacity for network transmissions, such as bandwidth, bit rate, channel capacity, and maximum throughput.

The complexity model 320 may determine the target work capacity based at least in part on historical access data 302. According to some examples, responsive to historical access data 302 comprising one or more previous target work capacities, the complexity model 320 may determine a target work capacity that differs from each of the one or more previous target work capacities. For example, if a previous target work capacity comprised a little to no processing capacity, a newly determined target work capacity may comprise a large processing capacity to test a different active part of the user device 338.

According to some examples, as a user device 338 makes repeated requests for access, the complexity model 320 intelligently engages the user device 338 in different types of challenges to collect access data 302. For example, a user device 338 more rapidly solving a challenge than similar user devices solving similar challenges may suggest the user device 338 is associated with an attacker. In some examples, the complexity model 320 may independently vary processing capacity, memory capacity, and network transmission capacity in the target work capacity of successive challenges. Responsive to a user device 338 being able to solve a first challenge with a high processing capacity uncharacteristically fast, the complexity model 320 may determine a target complexity 328 comprising a low processing capacity and high memory capacity to test a different portion of the user device 338. If the user device 338 is able to solve the second challenge uncharacteristically fast again, the predictive model 318 has strong indications the user device 338 is associated with an attacker.

Responsive to multiple requests for access, the complexity model 320 may generate a target work capacity that intentionally exceeds the capabilities of the user device 338; in other words, an ‘unsolvable’ challenge for the capabilities of the particular user device 338. In some examples, the unsolvable challenge may use up all the capacity on the user device 338 of an attacker and force the attacker to terminate the attack. If the user device 338 is subsequently able to solve the unsolvable challenge, the challenge management system 208 can determine the user device 338 is part of a distributed network of devices associated with an attacker and deny access.

The selection model 322 can select one or more problems 330 to be issued as a challenge to the user device 338 requesting access. The selection model 322 may operate in conjunction with the complexity model 320. In some examples, the selection model 322 may select a problem 330 based on a target complexity 328 received from the complexity model 320. In some examples, the complexity model 320 may determine the target complexity 328 based on a selected problem 330 received from the selection model 322. According to some implementations, the complexity model 320 and the selection model 322 may be one ML model 332.

According to some examples, responsive to receiving a target complexity 328 from the complexity model 320, the selection model 322 selects one or more problems 330 from the challenge repository system 304 where the selected problem(s) can be scaled to a target complexity 328. For example, responsive to receiving a target complexity 328 with a high network transmission capacity, the selection model 322 may select a network transmission problem 314 or a chained problem 316 comprising one or more network transmission problems 314.

According to some examples, the selection model 322 selects one or more problems 330 from the challenge repository system 304 based at least in part on access data 302. For example, the selection model 322 may select a type of problem that has not previously been issued to the user device 338. Additionally, or alternatively, the selection model 322 may assign problems based on learning over time which problems are most effective at deterring fraudulent access attempts. Additionally, or alternatively, the selection model 322 may select a problem based on the prediction 326. For example, the selection model 322 may be more likely to assign chained problems 316 to predicted attackers.

In examples where the complexity model 320 receives a selected problem 330 from the selection model 322, the at least one selected problem 330 may constrain the complexity model 320 in determining the target complexity 328. For example, responsive to selection of a cryptographic problem 310, the complexity model 320 would not be able to assign a high network traffic capacity for the target complexity 328 since large network traffic capacity is not necessary in solving cryptographic problems 310.

Responsive to the determining the target complexity 328 and the selecting the at least one problem 330, the scaling model 324 dynamically scales the at least one selected problem 330 to the target complexity 328. In some examples, the scaling model 324 generates one or more inputs 334 used to generate a challenge 336. According to some examples, the one or more inputs 334 are provided to the user device 338. In some examples, the inputs 334 may be written into one or more files served to the user device 338, where the file(s) after being updated with the one or more inputs 334 comprise the challenge 334. The scaling model 324 may use randomization to generate the one or more inputs 334.

According to some examples, the scaling model 324 scales the work capacity of a cryptographic problem 310 by changing a hashing algorithm of the cryptographic problem 310, changing logical operators of the cryptographic problem 310, and additionally, or alternatively, changing the hashing constants of the cryptographic problem 310. For example, the hashing constants may be replaced with one or more non-prime integers to increase complexity and make the cryptographic problem 310 resistant to multithreading. The one or more inputs 334 can change the hashing algorithm, change the logical operators, and change the hashing constants.

According to some examples, the scaling model 324 scales the work capacity of a satisfiability problem 312 by changing a number of clauses within the satisfiability problem 312, changing a number of variables within the satisfiability problem 312, and additionally, or alternatively, changing the logical operators of the satisfiability problem 312. For example, the logical operators may be completely rewritten for each challenge such that the satisfiability problem 312 cannot be predicted. The one or more inputs 334 can change the number of clauses, change the number of variables, and change the logical operators.

According to some examples, the scaling model 324 scales the work capacity of a network transmission problem 314 by changing a size of a payload of the network transmission problem 314, changing a number of transmissions in the network transmission problem 314 and additionally, or alternatively, changing a number of destinations for transmissions in the network transmission problem 314. The one or more inputs 334 can be a payload to change a size of the payload, change the number of transmissions, and change destinations for transmissions.

According to some examples, the scaling model 324 scales the work capacity of a chained problem 316 by scaling the respective work capacities of the proof-of-work problems in the chained problem 316. Additionally, or alternatively, the one or more inputs 334 can change the problems in the chained problem 316.

The scaling model 324 may provide the one or more inputs 334 to scale the at least one problem 330 to meet or exceed the target complexity 328, to the challenge service system 306.

### Challenge Service System

The challenge service system 306 can provide a scaled challenge 336 to a user device 338 responsive to a request to access content, resource, or service. The challenge service system 306 communicates with the challenge model system 210. In some examples, the challenge service system 306 receives the one or more inputs 334 from the scaling model 324. The challenge service system 306 may also receive the determined target complexity 328 and the selected problem 330 and the prediction 326. According to some examples, the challenge service system 306 generates a challenge 336 by providing the one or more inputs 334 to the selected problem 330.

According to some examples, the challenge service system 306 provides the challenge 336 to the user device 338 by transmitting the challenge 336 to the user device 338 over the network 102. According to some examples, the user device 338 may have previously received a version of the selected problem 330, and the challenge service system 306 provides the one or more inputs 334 to the user device 338 with instructions to input the one or more inputs 334 into the selected problem 330 to generate the scaled challenge 336.

In some examples, the cryptographic problem 310, satisfiability problem 312, and network transmission problem 314 are source files within an application 114 (e.g., a browser application with JavaScript files), each having a scalable work capacity. The challenge service system 306 may comprise a microservice or templating functionality to write the one or more inputs 334 to one or more files in near real-time to scale the problem 330 to the target complexity 328. In some examples, the microservice writes characters into the respective file to provide the challenge 336 to the user device 338 based on the one or more inputs 334 received from the scaling model 324. For example, the microservice of the challenge service system 306 may write logical operators into a satisfiability problem 312 source file to generate a challenge 336 comprising the satisfiability problem 312 scaled to the target complexity 328.

Additionally, or alternatively, the challenge service system 306 provides the challenge 336 to the user device 338, for example, through the API server 118. In some examples, the API server 118 exposes one or more API calls to request and/or deliver the one or more inputs 334 to the user device 338 to be written into source files within an application 114 (e.g., a browser application with JavaScript files) using template libraries.

The user device 338 is expected to solve, or otherwise attempt to solve, the scaled challenge 336 and provide a proof-of-work 340.

### Validity Checking System

The validity checking system 308 can determine whether a proof-of-work 340 received by the challenge management system 208 from the user device 338 is a valid proof-of-work for the issued challenge. According to some examples, the validity checking system 308 receives, from the user device 338, a proof-of-work 340 in response to the scaled challenge. The validity checking system 308 performs asymmetric computations to determine whether the received proof-of-work 340 is valid, according to some examples.

According to some examples, the validity checking system 308 may determine a computationally correct proof-of-work 340 is invalid if the user device 338 solved the challenge unusually quickly. This could indicate the user device 338 is associated with an attacker, or a lucky brute force solution by the user device 338, and the challenge management system 208 may issue another challenge to the user device 338 to gather more information.

Responsive to the validity checking system 308 determining the proof-of-work 340 is valid, the user device 338 is provided access to the content, resource, or service as requested. For example, the enterprise server system 106 issues an access token, such as a JSON web token (JWT). Responsive to the validity checking system 308 determining the proof-of-work 340 is invalid, the user device 338 is denied access to the content, resource, or service requested.

The validity checking system 308 may store the received proof-of-work or resultant determinations of validity in the access data 302, such as incrementing relevant counters of access attempts.

FIG. 4 is a flowchart depicting a machine-learning pipeline 400, according to some examples. The machine-learning pipeline 400 may be used by the artificial intelligence and machine learning system 206 to generate a trained model, for example the predictive model 318, the complexity model 320, the selection model 322, or the scaling model 324 to perform operations associated with generating a challenge.

Machine learning may involve using computer algorithms to automatically learn patterns and relationships in data, potentially without the need for explicit programming. Machine learning algorithms can be divided into three main categories: supervised learning, unsupervised learning, and reinforcement learning.
Supervised learning involves training a model using labeled data to predict an output for new, unseen inputs. Examples of supervised learning algorithms include linear regression, decision trees, and neural networks.
Unsupervised learning involves training a model on unlabeled data to find hidden patterns and relationships in the data. Examples of unsupervised learning algorithms include clustering, principal component analysis, and generative models like autoencoders.
Reinforcement learning involves training a model to make decisions in a dynamic environment by receiving feedback in the form of rewards or penalties. Examples of reinforcement learning algorithms include Q-learning and policy gradient methods.

Examples of specific machine learning algorithms that may be deployed, according to some examples, include logistic regression, which is a type of supervised learning algorithm used for binary classification tasks. Logistic regression models the probability of a binary response variable based on one or more predictor variables. Another example type of machine learning algorithm is Naïve Bayes, which is another supervised learning algorithm used for classification tasks. Naïve Bayes is based on Bayes' theorem and assumes that the predictor variables are independent of each other. Random Forest is another type of supervised learning algorithm used for classification, regression, and other tasks. Random Forest builds a collection of decision trees and combines their outputs to make predictions. Further examples include neural networks, which consist of interconnected layers of nodes (or neurons) that process information and make predictions based on the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms include decision trees, k-nearest neighbors, clustering algorithms, and deep learning algorithms such as convolutional neural networks (CNN), recurrent neural networks (RNN), and transformer models. The choice of algorithm depends on the nature of the data, the complexity of the problem, and the performance requirements of the application.

According to some examples, the predictive model 318 is implemented using unsupervised learning where the predictive model 318 learns over time to recognize patterns of fraudulent attackers, such as characteristics of user devices uses by attackers, characteristics of IP addresses or attackers, patterns in events (e.g., click, tap, keystroke), and other patterns and characteristics the predictive model 318 observes over time. Additionally, or alternatively, the predictive model 318 can learn to recognize such characteristics and patterns of behavior observed in legitimate users.

Moreover, attackers are known to sometimes ‘case the joint’ by acting as a legitimate user to gather information about the enterprise and existing security measures. The predictive model 318 may further recognize patterns of attackers acting as legitimate users, for example, by identifying patterns typically observed in attackers in a seemingly legitimate user. The predictive model 318 enables the challenge management system 208 to continue to learn and improve as attackers develop new techniques and methodologies.

According to some examples, the complexity model 320 and selection model 322 can be implemented using unsupervised learning where the respective model(s) learn over time which combinations of target complexities 328 and problems 330 work best at deterring fraudulent attacks. The complexity model 320 and selection model 322 may further learn patterns of successive combinations of target complexities 328 and problems 330 work best at deterring fraudulent attacks. The complexity model 320 may learn when and how much to increase or decrease target complexities 328 to best deter attacks and the selection model 322 may learn when to select particular problems 330 to best deter attacks. That is, the best deterrent may not be to continually increase the target complexity 328 on successive requests for access, but to dynamically change the target complexity 328 in unpredictable ways.

According to some examples, the scaling model 324 can be implemented using unsupervised learning where the scaling model 324 learns over time how to scale a problem to the target complexity. For example, the scaling model 324 may begin using brute force methods and learning over time methods and techniques to more quickly scale each different type of problem (e.g., cryptographic problem 310, satisfiability problem 312, network transmission problem 314, chained problem 316).

The performance of machine learning models is typically evaluated on a separate test set of data that was not used during training to ensure that the model can generalize to new, unseen data.

Although several specific examples of machine learning algorithms are discussed herein, the principles discussed herein can be applied to other machine learning algorithms as well. Deep learning algorithms such as convolutional neural networks, recurrent neural networks, and transformers, as well as more traditional machine learning algorithms like decision trees, random forests, and gradient boosting may be used in various machine learning applications.

Two example types of problems in machine learning are classification problems and regression problems. Classification problems, also referred to as categorization problems, aim at classifying items into one of several category values (e.g., a user device being classified as an attacker or legitimate user). Regression algorithms aim at quantifying some items (e.g., quantifying likelihood a user device is an attacker).

Generating a model (e.g., predictive model 318, complexity model 320, selection model 322, scaling model 324) may include multiple phases that form part of the machine-learning pipeline 400, including for example the following phases illustrated in FIG. 4:
Data collection and preprocessing 402: This phase may include acquiring and cleaning data (e.g., access data) to ensure that it is suitable for use in the machine learning model. This phase may also include removing duplicates, handling missing values, and converting data into a suitable format.
Feature engineering 404: This phase may include selecting and transforming the training data 508 to create features that are useful for predicting the target variable. Feature engineering may include (1) receiving features 510 (e.g., as structured or labeled data in supervised learning) and/or (2) identifying features 510 (e.g., unstructured or unlabeled data for unsupervised learning) in training data 508.
Model selection and training 406: This phase may include selecting an appropriate machine learning algorithm and training it on the preprocessed data. This phase may further involve splitting the data into training and testing sets, using cross-validation to evaluate the model, and tuning hyperparameters to improve performance.
Model evaluation 408: This phase may include evaluating the performance of a trained model (e.g., predictive model 318, complexity model 320, selection model 322, scaling model 324) on a separate testing dataset. This phase can help determine if the model is overfitting or underfitting and determine whether the model is suitable for deployment.
Prediction 410: This phase involves using a trained model (e.g., predictive model 318, complexity model 320, selection model 322, scaling model 324) to generate predictions on new, unseen data.
Validation, refinement or retraining 412: This phase may include updating a model based on feedback generated from the prediction phase, such as new data or user feedback.
Deployment 414: This phase may include integrating the trained model (e.g., predictive model 318, complexity model 320, selection model 322, scaling model 324) into a more extensive system or application, such as a web service, mobile app, or IoT device. This phase can involve setting up APIs, building a user interface, and ensuring that the model is scalable and can handle large volumes of data.

FIG. 5 illustrates further details of two example phases, namely a training phase 502 (e.g., part of the model selection and trainings 406 and model evaluation 408) and a deployment phase 504 (e.g., part of the prediction 410, validation, refinement or retraining 412, and deployment 414). Prior to the training phase 502, feature engineering 404 is used to identify features 510. This may include identifying informative, discriminating, and independent features for effectively operating a trained model 506 in pattern recognition, classification, and regression. As used herein, trained model 506 may refer to any model of the challenge model system 210 of FIG. 3, such as the predictive model 318, the complexity model 320, the selection model 322, the scaling model 324, or any combination thereof.

The training data 508 comprises a training version of access data 302, according to some examples. In some examples, the training data 508 includes labeled data, known for pre-identified features 510 and one or more outcomes. Each of the features 510 may be a variable or attribute, such as an individual measurable property of a process, article, system, or phenomenon represented by a data set (e.g., the training data 508). Features 510 may also be of different types, such as numeric features, strings, and graphs, and may include one or more of content 512, concepts 514, attributes 516, historical access features 518, and/or user device features 520, merely for example. The historical access features 518 can comprise features generated from historical access data in the training data 508. The user device features 520 can comprise features generated from user device information in the training data 508.

In training phase 502, the machine-learning pipeline 400 uses the training data 508 to find correlations among the features 510 that affect a predicted outcome or output 522. With the training data 508 and the identified features 510, the model is trained during the training phase 502 during model training 524. The model training 524 appraises values of the features 510 as they correlate to the training data 508. The result of the training is a trained or learned model 506 (e.g., predictive model 318, complexity model 320, selection model 322, scaling model 324).

Further, the training phase 502 may involve machine learning, in which the training data 508 is structured (e.g., labeled during preprocessing operations). The trained model 506 may implement a neural network 526 capable of performing, for example, classification and clustering operations. In other examples, the training phase 502 may involve deep learning, in which the training data 508 is unstructured, and the trained model 506 may implement a deep neural network 526 that can perform both feature extraction and classification/clustering operations.

In some examples, a neural network 526 may be generated during the training phase 502 and implemented within the trained model 506. The neural network 526 includes a hierarchical (e.g., layered) organization of neurons, with each layer consisting of multiple neurons or nodes. Neurons in the input layer receive the input data, while neurons in the output layer produce the final output of the network. Between the input and output layers, there may be one or more hidden layers, each consisting of multiple neurons.

Each neuron in the neural network 526 operationally computes a function, such as an activation function, which takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, affecting their performance on different tasks. The layered organization of neurons and the use of activation functions and weights enable neural networks to model complex relationships between inputs and outputs, and to generalize to new inputs that were not seen during training.

In some examples, the neural network 526 may also be one of several different types of neural networks, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 502, a validation phase may be performed on a separate dataset known as the validation dataset. The validation dataset is used to tune the hyperparameters of a model, such as the learning rate and the regularization parameter. The hyperparameters are adjusted to improve the model's performance on the validation dataset.

Once a model is fully trained and validated, in a testing phase, the trained model 506 may be tested on a new dataset. The testing dataset is used to evaluate the performance of the trained model 506 and ensure that the model has not overfitted the training data 508.

During deployment phase 504, the trained model 506 produce an output 522. Access data 302 may be provided as an input to the trained model 506, and the trained model 506 generates the output 522 responsive to receipt of the access data 302. In the deployment phase 504, the trained model 506 may use the features 510 for analyzing access data 302 to generate inferences, outcomes, or predictions, as examples of an output 522.

For example, the predictive model 318 can produce an output 522 that comprises a prediction about whether a user is an attacker. The complexity model 320 can produce an output 522 that comprises a target complexity (e.g., a target work capacity). The selection model 322 can produce an output 522 that comprises one or more selected proof-of-work problems. The scaling model 324 can produce an output 522 that comprises a scaled challenge.

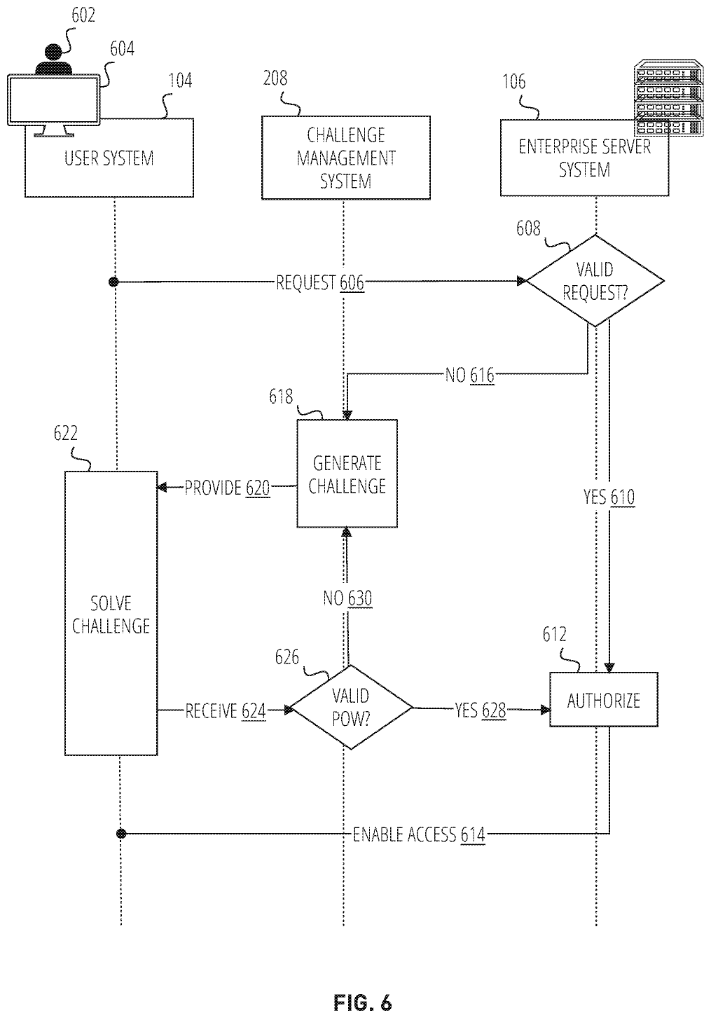

FIG. 6 is a diagrammatic representation of a user system 104 interacting with the challenge management system 208, according to some examples. As shown in FIG. 6, the challenge management system 208 interacts with the enterprise server system 106. It shall be appreciated that in some examples the enterprise server system 106 may be replaced by a third-party server 108 that provides authorization functionality. That is, the challenge management system can provide fraud deterring services to third-party servers 108.

The user system 104 as shown in FIG. 6 comprises a user 602 and a user device 604. The user 602 may be an attacker. Moreover, the user device 604 may be part of a distributed system of devices used by one or more attackers.

The user system 104 makes a request 606 to access content, resource, or service from the enterprise server system 106. The request 606 may be a request to login, a request to create an account, a request to make a deposit, a request to make a withdrawal, or any other content, resource, or service provided by the enterprise. The request 606 may be an HTTP request.

The enterprise server system 106 validates 608 the request 606. If yes 610, the request 606 is valid, the enterprise server system 106 authorizes 612 the request 606 and enables 614 access for the user system 104. The enterprise server system 106 may determine a request 606 is valid if the request 606 includes an access token (e.g., a JWT). The enterprise server system 106 may determine a request 606 is valid if it includes valid identification credentials (e.g., valid username and password at login). According to some examples, a challenge may not be issued if the initial request 606 is valid. In some examples, the API server 118 provides one or more API calls to check the validity of a JWT token.

If no 616, the request 606 is not valid, the challenge management system 208 generates 618 a challenge problem, for example, as described in relation to FIG. 3. A request 606 may be invalid if it includes a fraudulent or expired authentication, such as an expired access token. A request 606 may be invalid if the identification credentials are not valid (e.g., incorrect password, incorrect username). A request 606 may be invalid if it originates from a user device 604 not previously associated with the user account in the request 606 (e.g., a new device). The request 606 may be deemed invalid if it is otherwise suspected to originate from an attacker. According to some examples, the challenge management system 208 may validate 608 requests 606 in addition to or alternate to the enterprise server system 106. For example, the predictive model 318 may ingest access data relevant to the request 606 to determine whether the request 606 is valid 610 or invalid 616.

The challenge management system 208 provides 620 the challenge to the user system 104. The user device 604 of the user system 104 solves 622 the challenge and provides a proof-of-work to demonstrate the challenge has been solved 622. The challenge management system 208 receives 624 the proof-of-work from the user system 104.

The challenge management system 208 validates 626 the proof-of-work, for example, by the validity checking system 308 as discussed in FIG. 3. If yes 628, the proof-of-work is valid, the enterprise server system 106 authorizes 612 the request 606 and enables 614 access for the user system 104.

If no 630, the proof-of-work is not valid, the challenge management system 208 repeats the challenge cycle: generate 618 a second challenge, provide 620 the second challenge, wait for the user device 604 to solve 622 the second challenge, receive 624 a second proof-of-work. The challenge management system 208 validates 626 the second proof-of-work. If yes 628, the enterprise server system 106 authorizes 612 and enables 614 access to the user system 104. If no 630, the challenge cycle repeats a third, fourth, through Nth time, until the user device 604 generates a valid proof-of-work or quits.

As the challenge management system 208 repeats the challenge cycle for a particular user device 604, the challenge management system 208 may rapidly scale up the complexity of the challenges provided 620, for example, to force the user 602 to quit if they are an attacker. That is, if the complexity rapidly scales up, an attacker user 602 may run out of capacity available from free platform resources and quit the attack.

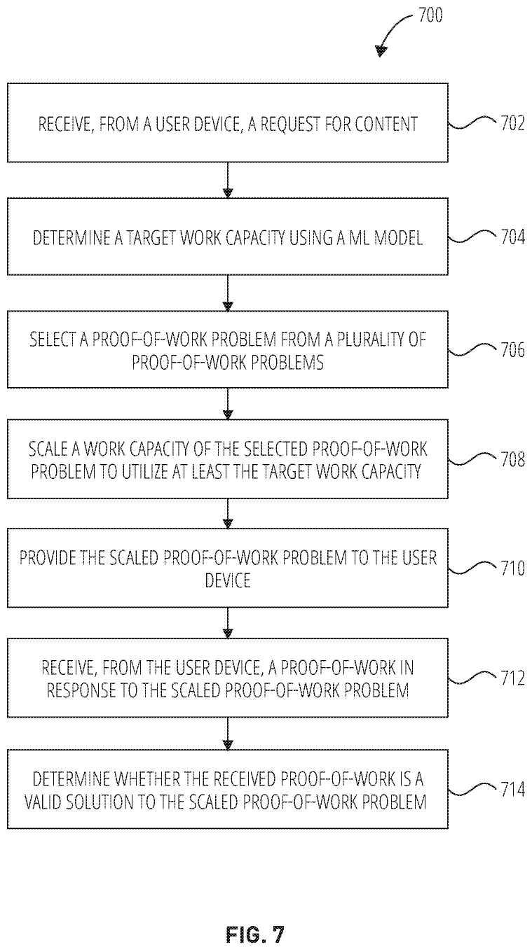

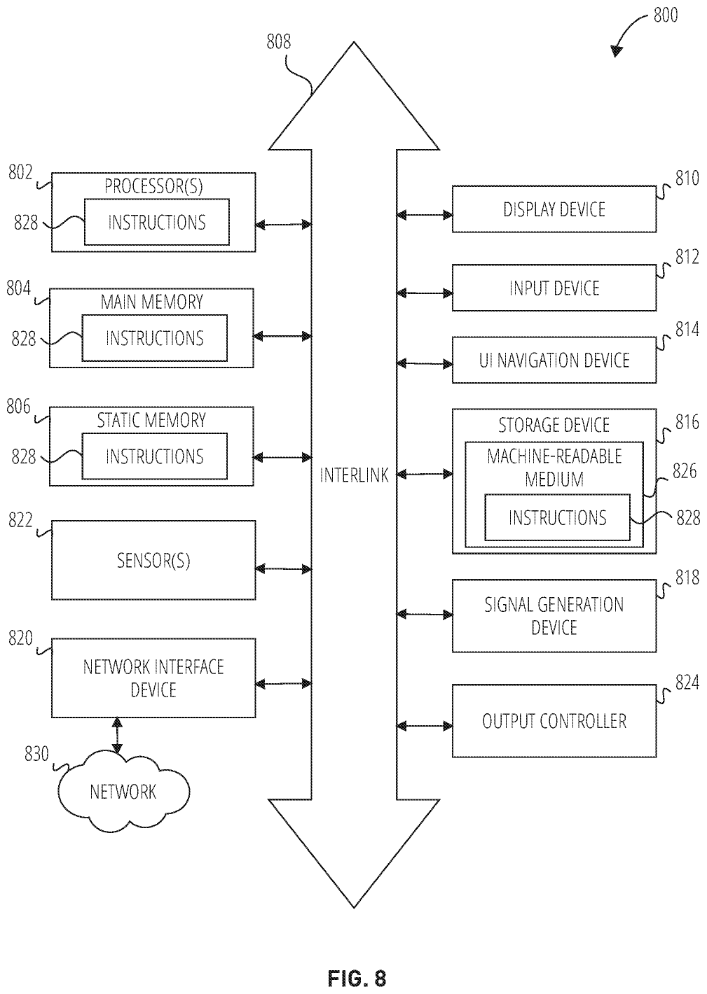

FIG. 7 illustrates a flowchart showing a technique 700 for scalable on-demand data transformation accordance with some embodiments. In an example, operations of the technique 700 may be performed by processing circuitry, for example by executing instructions stored in memory. The processing circuitry may include a processor, a system on a chip, or other circuitry (e.g., wiring). For example, technique 700 may be performed by processing circuitry of a device (or one or more hardware or software components thereof), such as those illustrated and described with reference to FIG. 8. According to some examples, the operations of the technique 700 are performed by the challenge management system 208.

The technique 700 includes an operation 702 to receive, from a user device, a request for content, resource, or service. The content, resource, or service may be gated and require authorization to access. The user device can be a device of an instance of the user system 104. In some examples, the request can include an HTTP request, such as GET, PUT, or POST, which may include a payload body.

The technique 700 includes an operation 704 to determine a target work capacity of the user device using a ML model. In some examples, one or more ML models are used. According to some examples, the complexity model 320 determines the target work capacity based in part on access data, information received from the predictive model 318, and additionally, or alternatively, based in part on information received from the selection model 322. In some examples, the target work capacity comprises a processing capacity, a memory capacity, and a network traffic capacity.

The technique 700 includes an operation 706 to select a proof-of-work problem from a plurality of proof-of-work problems. In some examples, the challenge repository system 304 maintains a plurality of proof-of-work problems, each problem having a scalable work capacity. According to some examples, the selection model 322 selects at least one proof-of-work problem from a plurality of proof-of-work problems maintained by the challenge repository system 304. In some examples, the selection model 322 selects the at least one proof-of-work problem based in part on information received from the complexity model 320 and additionally, or alternatively, access data.

The technique 700 includes an operation 708 to scale a work capacity of the selected proof-of-work problem to utilize at least the target work capacity. According to some examples, the scaling model 324 receives the at least one proof-of-work problem selected by the selection model 322 and the target work capacity determined by the complexity model 320. The scaling model 324 scales the selected proof-of-work problem such that the user device will utilize at least the target work capacity in generating a proof-of-work.

The technique 700 includes an operation 710 to provide the scaled proof-of-work problem to the user device. The challenge management system 208 may provide by communicating the scaled proof-of-work problem to the user system 104 over the network 102. According to some examples, the challenge service system 306 provides the scaled proof-of-work problem, for example, through a microservice.

The technique 700 includes an operation 712 to receive, from the user device, a proof-of-work in response to the scaled proof-of-work problem. Responsive to being provided the scaled proof-of-work problem, the user device generates a proof-of-work to solve the proof-of-work problem, typically by brute force. The generating the proof-of-work can occur without user input or intervention. The user device may provide the proof-of-work to the challenge management system 208 by communicating it over the network 102.

The technique 700 includes an operation 714 to determine whether the received proof-of-work is a valid solution to the scaled proof of work problem. According to some examples, the validity checking system 308 performs asymmetric computations to check whether the received proof-of-work is a valid solution to the scaled proof of work problem.

The technique 700 may include additional operations of responsive to determining the proof-of-work is valid, providing, to the user device, access to the content, resource, or service. Additionally, or alternatively, the technique 700 may include additional operations of responsive to determining the proof-of-work is invalid, denying, to the user device, access to the content, resource, or service.

FIG. 8 illustrates generally an example of a block diagram of a machine 800 upon which any one or more of the techniques (e.g., methodologies) discussed herein may perform in accordance with some embodiments. In alternative embodiments, the machine 800 may operate as a standalone device or may be connected (e.g., networked) to other machines. In a networked deployment, the machine 800 may operate in the capacity of a server machine, a client machine, or both in server-client network environments. In an example, the machine 800 may act as a peer machine in peer-to-peer (P2P) (or other distributed) network environment. The machine 800 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (Saas), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 800 may include a hardware processor(s) 802 (e.g., a CPU, a GPU, a hardware processor core, or any combination thereof), a main memory 804 and a static memory 806, some or all of which may communicate with each other via an interlink 808 (e.g., a bus). The machine 800 may further include a display device 810, an alphanumeric input device 812 (e.g., a keyboard), and a UI navigation device 814 (e.g., a mouse). In an example, the display device 810, alphanumeric input device 812 and UI navigation device 814 may be a touch screen display. The machine 800 may additionally include a storage device 816 (e.g., drive unit), a signal generation device 818 (e.g., a speaker), a network interface device 820, and one or more sensor(s) 822, such as a global positioning system (GPS) sensor, compass, accelerometer, or other sensor. The machine 800 may include an output controller 824, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 816 may include a machine readable machine-readable medium 826 that is non-transitory on which is stored one or more sets of data structures or instructions 828 (e.g., software) embodying or utilized by any one or more of the techniques or functions described herein. The instructions 828 may also reside, completely or at least partially, within the main memory 804, within static memory 806, or within the hardware processor(s) 802 during execution thereof by the machine 800. In an example, one or any combination of the hardware processor(s) 802, the main memory 804, the static memory 806, or the storage device 816 may constitute machine readable media.

While the machine readable machine-readable medium 826 is illustrated as a single medium, the term “machine readable medium” may include a single medium or multiple media (e.g., a centralized or distributed database, or associated caches and servers) configured to store the one or more instructions 828.

The term “machine readable medium” may include any medium that is capable of storing, encoding, or carrying instructions for execution by the machine 800 and that cause the machine 800 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 828 may further be transmitted or received over a communications network 830 using a transmission medium via the network interface device 820 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 820 may include one or more physical jacks (e.g., Ethernet, coaxial, or phone jacks) or one or more antennas to connect to the communications network 830. In an example, the network interface device 820 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 800, and includes digital or analog communications signals or other intangible medium to facilitate communication of such software.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventor also contemplates examples in which only those elements shown or described are provided. Moreover, the present inventor also contemplates examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” can include “A but not B,” “B but not A,” and “A and B,” unless otherwise indicated. In the appended claims, the terms “including” and “in which” are used as the plain-English equivalents of the respective terms “comprising” and “wherein”. Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) can be used in combination with each other. Other embodiments can be used, such as by one of ordinary skill in the art upon reviewing the above description. It is submitted with the understanding that it will not be used to interpret or limit the scope or meaning of the claims. Also, in the above Detailed Description, various features can be grouped together to streamline the disclosure. This should not be interpreted as intending that an unclaimed disclosed feature is essential to any claim. Rather, inventive subject matter can lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The following, non-limiting examples, detail certain aspects of the present subject matter to solve the challenges and provide the benefits discussed herein, among others.

Example 1 is a method comprising receiving, from a user device, a request for a resource; determining a target work capacity of the user device using a machine-learning (ML) model; selecting a proof-of-work problem from a plurality of proof-of-work problems, each proof-of-work problem in the plurality of proof-of-work problems having scalable work capacity; scaling a work capacity of the selected proof-of-work problem to utilize at least the target work capacity; providing the scaled proof-of-work problem to the user device; receiving, from the user device, a proof-of-work in response to the scaled proof-of-work problem; and determining whether the received proof-of-work is a valid solution to the scaled proof-of-work problem.

Example 2 is the method of Example 1, further comprising: responsive to determining the proof-of-work is valid, providing, to the user device, access to the resource.

Example 3 is the method of Example 1, further comprising: responsive to determining the proof-of-work is invalid, denying, to the user device, access to the resource.

Example 4 is the method of Example 1, wherein the plurality of proof-of-work problems comprise a cryptographic problem, a satisfiability problem, and a network transmission problem.

Example 5 is the method of Example 4, wherein the scaling the work capacity of the cryptographic problem comprises: changing a cryptographic algorithm of the cryptographic problem; and changing logical operators of the cryptographic problem.

Example 6 is the method of Example 4, wherein the scaling the work capacity of the satisfiability problem comprises: scaling a number of clauses of the satisfiability problem; scaling a number of variables of the satisfiability problem; and changing logical operators of the satisfiability problem.

Example 7 is the method of Example 4, wherein the scaling the work capacity of the network transmission problem comprises: changing a size of a payload of the network transmission problem; and changing a number of transmissions in the network transmission problem.

Example 8 is the method of Example 4, wherein the plurality of proof-of-work problems further comprises a chained problem, the chained problem comprising a set of scaled proof-of-work problems; and wherein the proof-of-work received in response to the chained problem comprises a respective proof-of-work for each scaled proof-of-work problem in the set of the scaled proof-of-work problems.

Example 9 is the method of Example 8, wherein the scaling the work capacity of the chained problem comprises: scaling a number of scaled proof-of-work problems in the set of the scaled proof-of-work problems.

Example 10 is the method of Example 1, wherein the target work capacity comprises a processing capacity, a memory capacity, and a network traffic capacity.

Example 11 is the method of Example 1, wherein the ML model analyzes historical access data comprising one or more previous target work capacities, and wherein the determined target work capacity differs from each of the one or more previous target work capacities.

Example 12 is A system comprising: processing circuitry; and memory, including instructions, which when executed by the processing circuitry, causes the processing circuitry to perform operations to: receive, from a user device, a request for a resource; determine a target work capacity of the user device using a machine-learning (ML) model; select a proof-of-work problem from a plurality of proof-of-work problems, each proof-of-work problem in the plurality of proof-of-work problems having scalable work capacity; scale a work capacity of the selected proof-of-work problem to utilize at least the target work capacity; provide the scaled proof-of-work problem to the user device; receive, from the user device, a proof-of-work in response to the scaled proof-of-work problem; and determine whether the received proof-of-work is a valid solution to the scaled proof-of-work problem.

Example 13 is the system of Example 12, wherein the instructions further cause the processing circuitry to: responsive to determining the proof-of-work is valid, provide, to the user device, access to the resource.

Example 14 is the system of Example 12, wherein the instructions further cause the processing circuitry to: responsive to determining the proof-of-work is invalid, deny, to the user device, access to the resource.

Example 15 is the system of Example 12, wherein the plurality of proof-of-work problems comprise a cryptographic problem, a satisfiability problem, and a network transmission problem.

Example 16 is the system of Example 15, wherein the scaling the work capacity of the cryptographic problem comprises: change a cryptographic algorithm of the cryptographic problem; and change logical operators of the cryptographic problem.

Example 17 is the system of Example 15, wherein the scaling the work capacity of the satisfiability problem comprises: change a number of clauses of the satisfiability problem; change a number of variables of the satisfiability problem; and change logical operators of the satisfiability problem.

Example 18 is the system of Example 15, wherein the scaling the work capacity of the network transmission problem comprises: change a size of a payload of the network transmission problem; and change a number of transmissions in the network transmission problem.

Example 19 is the system of Example 15, wherein the plurality of proof-of-work problems further comprises a chained problem, the chained problem comprising a set of scaled proof-of-work problems; and wherein the proof-of-work received in response to the chained problem comprises a respective proof-of-work for each scaled proof-of-work problem in the set of the scaled proof-of-work problems.

Example 20 is A non-transitory computer-readable storage medium, the computer-readable storage medium including instructions that when executed by a computer, cause the computer to: receive, from a user device, a request for a resource; determine a target work capacity of the user device using a machine-learning (ML) model; select a proof-of-work problem from a plurality of proof-of-work problems, each proof-of-work problem in the plurality of proof-of-work problems having scalable work capacity; scale a work capacity of the selected proof-of-work problem to utilize at least the target work capacity; provide the scaled proof-of-work problem to the user device; receive, from the user device, a proof-of-work in response to the scaled proof-of-work problem; and determine whether the received proof-of-work is a valid solution to the scaled proof-of-work problem.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

What is claimed is:

1. A method comprising:
receiving, from a user device, a request for a resource;
determining a target work capacity of the user device using a machine-learning (ML) model;
selecting a proof-of-work problem from a plurality of proof-of-work problems, each proof-of-work problem in the plurality of proof-of-work problems having scalable work capacity;
scaling a work capacity of the selected proof-of-work problem to utilize at least the target work capacity;
providing the scaled proof-of-work problem to the user device;
receiving, from the user device, a proof-of-work in response to the scaled proof-of-work problem; and
determining whether the received proof-of-work is a valid solution to the scaled proof-of-work problem.

2. The method of claim 1, further comprising:
responsive to determining the proof-of-work is valid, providing, to the user device, access to the resource.

3. The method of claim 1, further comprising:
responsive to determining the proof-of-work is invalid, denying, to the user device, access to the resource.

4. The method of claim 1, wherein the plurality of proof-of-work problems comprise a cryptographic problem, a satisfiability problem, and a network transmission problem.

5. The method of claim 4, wherein the scaling the work capacity of the cryptographic problem comprises:
changing a cryptographic algorithm of the cryptographic problem; and
changing logical operators of the cryptographic problem.

6. The method of claim 4, wherein the scaling the work capacity of the satisfiability problem comprises:
scaling a number of clauses of the satisfiability problem;
scaling a number of variables of the satisfiability problem; and
changing logical operators of the satisfiability problem.

7. The method of claim 4, wherein the scaling the work capacity of the network transmission problem comprises:
changing a size of a payload of the network transmission problem; and
changing a number of transmissions in the network transmission problem.

8. The method of claim 4, wherein the plurality of proof-of-work problems further comprises a chained problem, the chained problem comprising a set of scaled proof-of-work problems; and
wherein the proof-of-work received in response to the chained problem comprises a respective proof-of-work for each scaled proof-of-work problem in the set of the scaled proof-of-work problems.

9. The method of claim 8, wherein the scaling the work capacity of the chained problem comprises:
scaling a number of scaled proof-of-work problems in the set of the scaled proof-of-work problems.

10. The method of claim 1, wherein the target work capacity comprises a processing capacity, a memory capacity, and a network traffic capacity.

11. The method of claim 1, wherein the ML model analyzes historical access data comprising one or more previous target work capacities, and wherein the determined target work capacity differs from each of the one or more previous target work capacities.

12. A system comprising:
processing circuitry; and
memory, including instructions, which when executed by the processing circuitry, causes the processing circuitry to perform operations to:
receive, from a user device, a request for a resource;
determine a target work capacity of the user device using a machine-learning (ML) model;
select a proof-of-work problem from a plurality of proof-of-work problems, each proof-of-work problem in the plurality of proof-of-work problems having scalable work capacity;
scale a work capacity of the selected proof-of-work problem to utilize at least the target work capacity;
provide the scaled proof-of-work problem to the user device;
receive, from the user device, a proof-of-work in response to the scaled proof-of-work problem; and
determine whether the received proof-of-work is a valid solution to the scaled proof-of-work problem.

13. The system of claim 12, wherein the instructions further cause the processing circuitry to:
responsive to determining the proof-of-work is valid, provide, to the user device, access to the resource.

14. The system of claim 12, wherein the instructions further cause the processing circuitry to:
responsive to determining the proof-of-work is invalid, deny, to the user device, access to the resource.

15. The system of claim 12, wherein the plurality of proof-of-work problems comprise a cryptographic problem, a satisfiability problem, and a network transmission problem.

16. The system of claim 15, wherein the scaling the work capacity of the cryptographic problem comprises:
change a cryptographic algorithm of the cryptographic problem; and
change logical operators of the cryptographic problem.

17. The system of claim 15, wherein the scaling the work capacity of the satisfiability problem comprises:
change a number of clauses of the satisfiability problem;
change a number of variables of the satisfiability problem; and
change logical operators of the satisfiability problem.

18. The system of claim 15, wherein the scaling the work capacity of the network transmission problem comprises:
change a size of a payload of the network transmission problem; and
change a number of transmissions in the network transmission problem.

19. The system of claim 15, wherein the plurality of proof-of-work problems further comprises a chained problem, the chained problem comprising a set of scaled proof-of-work problems; and
wherein the proof-of-work received in response to the chained problem comprises a respective proof-of-work for each scaled proof-of-work problem in the set of the scaled proof-of-work problems.

20. A non-transitory computer-readable storage medium, the computer-readable storage medium including instructions that when executed by a computer, cause the computer to:
receive, from a user device, a request for a resource;
determine a target work capacity of the user device using a machine-learning (ML) model;
select a proof-of-work problem from a plurality of proof-of-work problems, each proof-of-work problem in the plurality of proof-of-work problems having scalable work capacity;
scale a work capacity of the selected proof-of-work problem to utilize at least the target work capacity;
provide the scaled proof-of-work problem to the user device;
receive, from the user device, a proof-of-work in response to the scaled proof-of-work problem; and
determine whether the received proof-of-work is a valid solution to the scaled proof-of-work problem.
